(19) United States
(12) Patent Application Publication
(10) Pub. No.: US 2006/0087049 A1
(43) Pub. Date: Apr. 27, 2006

(54) Glass repair apparatus and method therefore

(76) Inventors: Christopher Davies, Kidwelly (GB); Martin Bloomfield, London (GB); Mir Saeed Zahedi, London (GB)

Correspondence Address: GORDON & JACOBSON, P.C., 60 LONG RIDGE ROAD, SUITE 407, STAMFORD, CT, 06902, US

(21) Appl. No.: 10/522,645

(22) PCT Filed: Aug. 1, 2003
(86) PCT No.: PCT/GB03/03357

§ 371 Date: Sep. 28, 2005

(30) Foreign Application Priority Data
Aug. 2, 2002 (GB) 0217922.4

(51) Int. Cl. B29C 73/00; C03B 23/00

(52) U.S. Cl. 264/36.21; 65/28; 65/273

(57) ABSTRACT

A windscreen heater is used for heating a windscreen prior to and/or during resin repair. The heated windscreen promotes the flow of resin to repair the windscreen. The device is mounted to the windscreen and has a port enabling viewing of a target zone of the windscreen. A heater element is positioned in the region of the port in order to effect heating of the windscreen.

The present invention relates to a windscreen heater device and particularly to such a device for use in a method of repairing a flaw (such as a crack or break) in a windscreen or other glazing panel.

The term windscreen should be interpreted broadly throughout as including vehicular or architectural glazing panels.

Frequently flaws such as small cracks or breaks in glazing panels (particularly vehicle windscreens) are repaired by means of infilling with a resin which when cured has optical and structural properties which mean that the optical and structural integrity of the glazing panel is not compromised.

It has been found that in order to avoid propagation of the crack or break following repair, the infilling resin needs to completely fill the crack or break. In cold ambient conditions flow of resin is inhibited and consequently it is sometimes difficult to ensure that the crack or break (flaw) is completely infilled. Known apparatus for repairing flaws (cracks or breaks) in glazing panels is disclosed, for example, in WO-A-01343373. The apparatus disclosed in WO-A-01343373 operates to apply resin to the flaw under an applied vacuum.

An improved technique and device has now been devised.

According to a first aspect, the present invention provides a windscreen heater device comprising:
a mounting arrangement for mounting the heater device relative to the windscreen;
a port enabling viewing of a target zone of the windscreen; and,
a heater element positioned in the region of the port.

Beneficially, the heater element is positioned peripherally of the port, preferably extending peripherally of the port.

It is preferred that the heating element comprises a heater band extending peripherally about the port. Beneficially the heater element comprises an annular heater element and is preferably an electrical resistence heating element. In a preferred embodiment the heater element comprises an electrical annular silicone mat or pad heater. The heater element is beneficially held in contact with the windscreen surface. The mounting means may be configured to ensure that the heating element is biased into to engagement with the windscreen. Spring means may be provided for this purpose or the inherent resilience of elements comprising the mounting arrangement may ensure such biasing.

It is preferred that when mounted relative to the screen, the port and heater element can be moved relative to the windscreen. The port and heater elements are beneficially arranged substantially co-axially with one another. The port may comprise an aperture through a support arm. In one embodiment a support body is provided between the annular heating element and the support arm, the support body also including an aperture comprising the port.

It is preferred that when mounted relative the screen, the port and heating element can be moved pivotally over the windscreen.

Beneficially the mounting arrangement includes three or more points of mounting contact to the screen. The mounting means may include one or more sucker cups or other vacuum fixing arrangement.

It is preferred that the windscreen heating device includes:
a first support element having mounting means for mounting to the windscreen; and,
a second support element pivotally connected to the first support element and carrying the port and heater element.

The second support element beneficially also includes mounting means for mounting to the windscreen.

It is preferred that the device includes temperature indication means (such as a thermometer) to give an indication of the windscreen temperature.

According to a second aspect, there is provided a method of heating a windscreen using a windscreen heater device as herein defined, where the device is mounted to the underside (vehicle interior) surface of the windscreen.

According to a further aspect, the present invention provides a method of repairing a flaw (such as a crack or break) in a vehicle windscreen, wherein a vehicle windscreen heater device as herein defined is mounted adjacent the windscreen with the flaw visible through the port. Heat is applied to the screen by the heater element and the flaw infilled with resin.

Beneficially the heater device is mounted to the underside (vehicle interior) surface of the windscreen. The flaw is beneficially repaired with resin whilst heat is simultaneously applied by the heating element of the device mounted to the underside (vehicle interior) of the windscreen. Beneficially repair apparatus is mounted to the outside surface of the windscreen in the region of the flaw, the outside mounted repair apparatus being operated to repair the flaw with resin whilst heat is simultaneously applied by the heating element of the heater device mounted to the underside (vehicle interior) surface of the windscreen. Preferred repair apparatus is capable of being mounted on the windscreen, and is preferably arranged to deliver resin under partial vacuum conditions, such as disclosed for example in WO-A-01343373.

The invention will now be further described in a specific embodiment, by way of example only and with reference to the accompanying drawings in which:

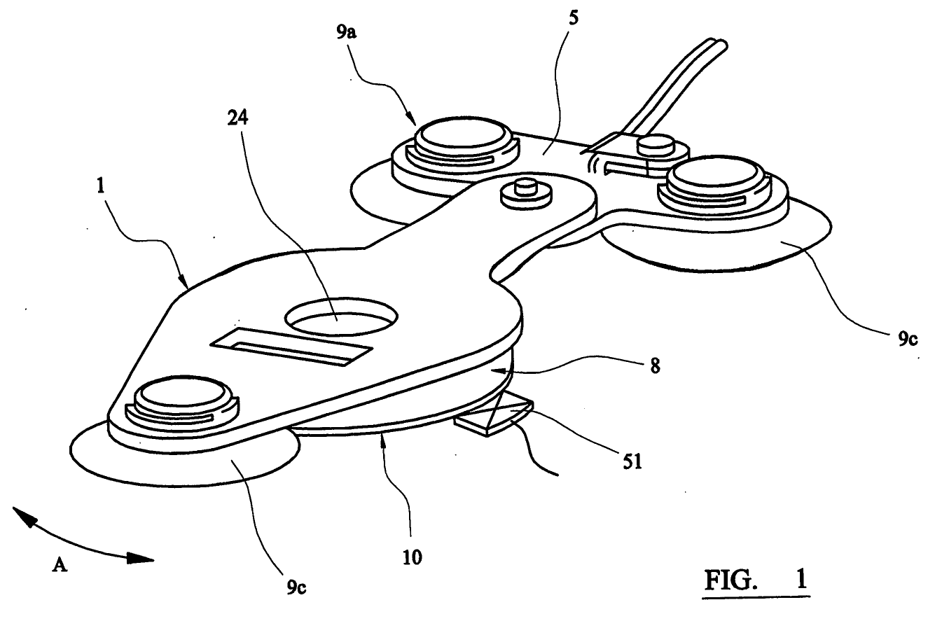

FIG. 1 is a perspective view of a windscreen heater device in accordance with the invention; and

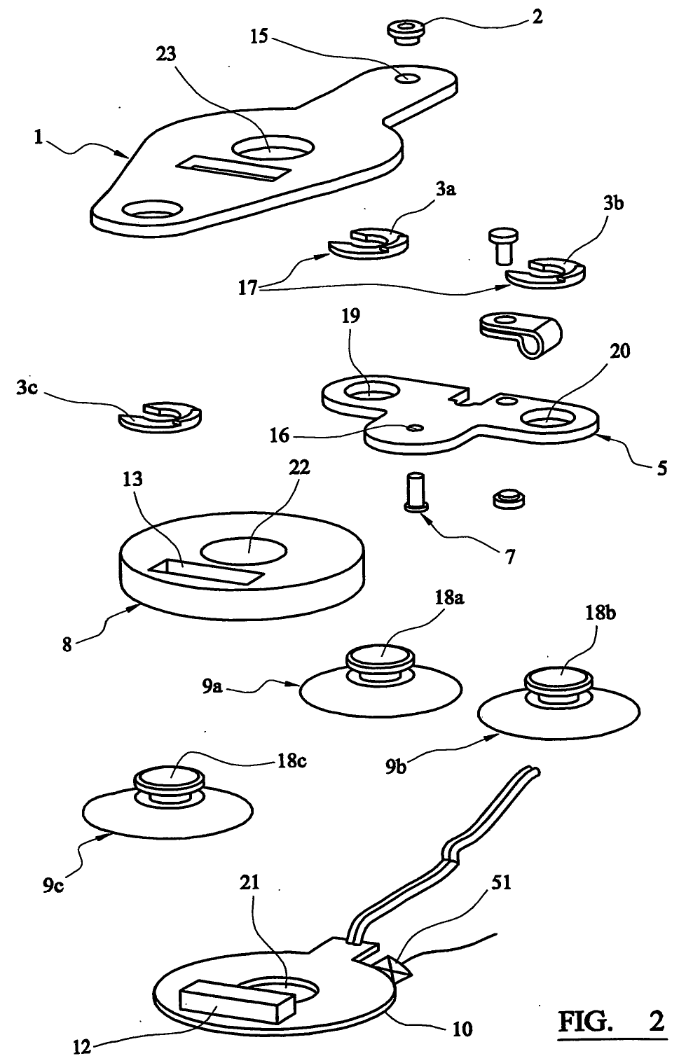

FIG. 2 is an exploded perspective view of the device of FIG. 1.

Referring to the drawings, the windscreen heater device comprises an annular neoprene body 8 to which is secured an annular silicone electrical resistence heating ring 10 (power rating 4 W). A thermostat 12 carried by heater ring 10 is received within a complementary recess 13 provided in annular body 8.

The washer 8 and heating ring 10 subassembly is carried by a support arm 1 which at a proximal end has an aperture 15 for receiving a pin 7 and bush 2 pivot connection to swing plate 5 (through aperture 16).

The distal end of arm 1 includes an aperture 17 for receiving the stem portion 18c of a sucker cup 19c. Retaining clip 3c secures the sucker cup 9c.

The swing plate 5 includes corresponding apertures 19, 20 for receiving sucker cups 9a, 9b. Corresponding securing clips 3a, 3b are provided.

Heating ring 10 is provided with an axial aperture 21 which aligns with central aperture 22 of annular body 8 and also a corresponding co-aligned aperture 23 provided through arm 1. In the assembly apertures 21, 22 and 23 are co-aligned providing a viewing or observation port through the entire device.

As shown in the assembled configuration in FIG. 1, the device can be retained on the surface of a vehicle windscreen by the sucker cups 9a, 9b, 9c. The device is typically situated on the underside of the vehicle windscreen with the viewing port 24 (defined by apertures 21, 22, 23) positioned under a subject crack, chip or break on the external surface of the vehicle windscreen. Sucker cup 9c may be released from the windscreen and the arm 1 pivoted in the direction of arrow A in FIG. 1 completely out of the way of the zone of the crack or break in order to permit further more detailed observation of the break or crack.

With the device secured in position, the heating ring 10, is held in contact with the underside of the vehicle windscreen. The heating ring 10 is activated to provide an annular heating zone around the zone of the crack or break via the underside of the windscreen. A thermometer device 51 provides an indication of the windscreen temperature.

Whilst the heating device is in operation providing heat to the windscreen, on the obverse face of the windscreen (the exterior surface) the crack or break is repaired by infilling the crack with resin.

A resin applicator device (such as a vacuum application device) may be used to deliver resin to the crack on the exterior of the windscreen surface. An example of such apparatus is disclosed in WO-A-0134373. A feature of the present invention is the ability to heat the windscreen at the region of the crack or break whilst such crack repair apparatus is present on the exterior of the surface for infilling the crack or break with resin.

The heater of the present invention provides sufficient heat to ensure that the resin flow characteristics are optimised in order to ensure maximum infilling of the crack or break with resin.

The apparatus of the invention is particularly suited to use in cold ambient conditions where the screen temperature is such that resin flow inhibition would be likely to occur.

The heater device of the present invention has been shown to enable the screen temperature to be raised by 10° C.-25° C. in two to five minutes at starting screen temperatures of −5° C. to 10° C.

1. A windscreen heater device comprising:
a mounting arrangement for mounting the heater device relative to the windscreen;
a port enabling viewing of a target zone of the windscreen; and
a heater element positioned in the region of the port.

2. A windscreen heater device according to claim 1, wherein the heater element extends peripherally of the port.

3. A windscreen heater device according to claim 1, wherein the heater element comprises an annular heater element.

4. A windscreen heater device according to claim 1, wherein the heater element comprises an electrical resistance heating element.

5. A windscreen heater device according to claim 1, wherein the heater element is held in contact with the windscreen surface.

6. A windscreen heater device according to claim 1, wherein, when mounted relative to the screen, the port and heater element can be moved relative to the windscreen.

7. A windscreen heating device according to claim 6, wherein, when mounted relative to the screen, the port and heater element can be moved pivotally over the windscreen.

8. A windscreen heating device according to claim 1, wherein the mounting includes three or more points of mounting to the screen.

9. A windscreen heating device according to claim 1, wherein the mounting means includes one or more sucker cups.

10. A windscreen heating device according to claim 1, including: a first support element having mounting means for mounting to the windscreen; and, a second support element pivotally connected to the first support element and carrying the port and heater element.

11. A windscreen heater device according to claim 10, wherein the second support element includes mounting means for mounting to the windscreen.

12. A method of heating a windscreen comprising:
providing a windscreen heater device including a mounting arrangement for mounting the heater device relative to the windscreen, a port enabling viewing of a target zone of the windscreen, and a heater element positioned in the region of the port;
manipulating the mounting arrangement to mount the windscreen heater device to an (vehicle interior) surface of the windscreen; and
using the heater element to heat the windscreen in the region of the port.

13. A method of repairing a flaw in a vehicle windscreen, comprising:
providing a windscreen heater device including a mounting arrangement for mounting the heater device relative to the windscreen, a port enabling viewing of a target zone of the windscreen, and a heater element positioned in the region of the port;
manipulating the mounting arrangement such that the windscreen heater device is mounted adjacent the windscreen with the flaw visible through the port; and
infllling the flaw with resin and using the heater element to apply heat to the windscreen and the flaw.

14. A method according to claim 13, wherein the windscreen heater device is mounted to a (vehicle interior) surface of the windscreen.

15. A method according to claim 13, wherein the flaw is repaired with resin whilst heat is simultaneously applied by the heating element of the device.

16. A method according to claim 14, further comprising mounting a repair apparatus to the outside surface of the windscreen in the region of the flaw, and operating the outside mounted repair apparatus to repair the flaw with resin whilst heat is simultaneously applied by the heating element of the device.

17-18. (canceled)
